(19) United States
(12) Patent Application Publication
(10) Pub. No.: US 2020/0077056 A1
(43) Pub. Date: Mar. 5, 2020

(54) SHOE CAPABLE OF CHANGING IMAGES

(71) Applicants: Yong Ho Ha, Busan (KR); Hyun Ju Ha, Busan (KR)

(72) Inventors: Yong Ho Ha, Busan (KR); Hyun Ju Ha, Busan (KR)

(21) Appl. No.: 16/674,151

(22) Filed: Nov. 5, 2019

Related U.S. Application Data
(63) Continuation of application No. PCT/KR2018/009952, filed on Aug. 29, 2018.

(30) Foreign Application Priority Data
Oct. 25, 2017 (KR) 10-2017-0139443

(51) Int. Cl. H04N 9/31; A43B 3/00; G09F 19/18

(52) U.S. Cl. CPC H04N 9/3141; G09F 19/18; A43B 3/001

(57) ABSTRACT

Shoe capable of projecting images that can be changed, wherein the shoe can not only change images projected in front thereof, so as to attract a wearer's interest, but can also naturally induce his or her walking. The subject matter of the present invention is a shoe capable of projecting images that can be changed, the shoe including a shoe body and an image projector detachably attached to the shoe body so as to project an image onto the ground, wherein the image projector comprises: a light source for emitting light; an image cell installed in front of the light source so as to form an image to be projected; and an image changing means for transmitting a control signal to the image cell so as to change the image to be projected.

### REFERENCE TO RELATED APPLICATIONS

This is a continuation of International Patent Application PCT/KR2018/009952 filed on Aug. 29, 2018, which designates the United States and claims priority of Korean Patent Application No. 10-2017-0139443 filed on Oct. 25, 2017, the entire contents of which are incorporated herein by reference.

### FIELD OF THE INVENTION

The present invention relates to a shoe capable of projecting images that can be changed. More particularly, the present invention relates to a shoe capable of projecting images that can be changed, in which the shoe can not only change images projected in front thereof, so as to attract a wearer's interest, but can also naturally induce his or her walking.

### BACKGROUND OF THE INVENTION

Recently, as lifestyle has changed rapidly, means of transportation have changed, food has become westernized, and children who spend a lot of time in private education have reduced activity, child obesity has rapidly increased from 11.6% to 15.0%.

This may be caused by activity habits of enjoying smart phones and computer games indoors rather than exercising outdoors during free times.

In consideration of this problem, shoes configured to induce the walking of children who are sensitive to visual stimuli rather than auditory stimuli have been continuously developed.

As one example, as a character sticker or a luminous sticker is attached to a shoe or a shoe is provided with a light emitter to emit light, this entices children who spend time only indoors to walk outdoors, thus achieving exercise effects.

As another example, a “Shoe Using Beams to Induce Walking (Korean Patent No. 10-1751536)” includes a beam projection unit that is provided at a predetermined position in a cover covering a space opened at a front of a shoe upper to open or close the space and projects an image towards a front of the shoe, a lens that is installed in a hole formed through a front of the cover, and a beam reflection unit that is installed between the lens and the beam projection unit and reflects the image projected by the beam projection unit to the front of the shoe to display the image outside of the lens.

However, since the “Shoe Using Beams to Induce Walking” is merely configured to project only a single image towards the front of the shoe, it is insufficient to attract wearer interest. Therefore, there is an urgent need to develop new shoes that can attract wearer interest and can naturally induce his or her walking.

### SUMMARY OF THE INVENTION

The present invention has been made to solve the above-mentioned problems and difficulties and relates to a shoe capable of projecting images that can be changed, in which the shoe can not only change images projected in front thereof, so as to attract a wearer's interest, but can also naturally induce his or her walking.

In order to accomplish the above object, the present invention provides a shoe capable of projecting images that can be changed, the shoe including a shoe body and an image projector detachably attached to the shoe body so as to project an image onto the ground, wherein the image projector may include a light source configured to emit light; an image cell installed in front of the light source so as to form an image to be projected; and an image changing means configured to transmit a control signal to the image cell so as to change the image to be projected.

The image projector may further include a battery to which electrical energy is supplied; and a lens assembly installed in front of the image cell to be spaced apart therefrom, and configured such that the image formed on the image cell is projected onto the ground.

The lens assembly may include at least one of a concave lens, a convex lens and a plane lens.

The image changing means may include a memory unit in which multiple images are stored; and a controller controlling to load an image that is pre-programmed and is stored in the memory unit, and to transmit the image to the image cell.

The image changing means may further include a wireless communication means connecting the controller with a terminal to transmit image change information.

The wireless communication means may include any one of WLAN, Wi-Fi, and Bluetooth.

The image changing means may further include a change switch connected to the controller to manually change the image stored in the memory unit.

A shoe capable of projecting images that can be changed according to the present invention can not only attract a wearer's interest, but can also naturally induce his or her walking, by variously changing an image projected onto the ground in front of a shoe wirelessly or manually.

### BRIEF DESCRIPTION OF THE DRAWINGS

FIGS. 1A and 1B are views illustrating a shoe assembling operation in accordance with a preferred embodiment of the present invention.

FIG. 2 is a view illustrating a state where an image is changed wirelessly in accordance with a preferred embodiment of the present invention.

FIG. 3 is a schematic view illustrating an image projector in accordance with a preferred embodiment of the present invention.

FIG. 4 is a view illustrating a state where an image is changed manually in accordance with a preferred embodiment of the present invention.

FIG. 5 is another schematic view illustrating an image projector in accordance with a preferred embodiment of the present invention.

### DETAILED DESCRIPTION OF THE INVENTION

Hereinafter, embodiments of the present invention will be described in detail with reference to the accompanying drawings.

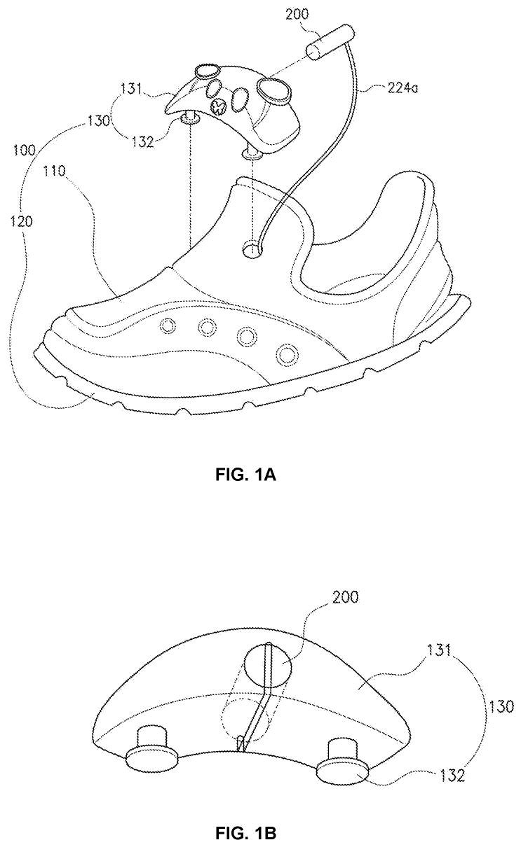

FIGS. 1A and 1B are views illustrating a shoe assembling operation in accordance with a preferred embodiment of the present invention. FIG. 1A illustrates a state where an image projector 200 is inserted into a cover 130 that is detachably installed on a shoe body 100, and FIG. 1B is a rear view of the image projector 200.

As illustrated in FIGS. 1A and 1B, the shoe body 100 in accordance with the preferred embodiment of the present invention may an upper 110 that covers the top of the foot, an outsole 120 with which the sole of the foot is in contact, and a character-shaped cover 130 that is detachably attached to a front of the upper 110.

Here, the cover 130 may include a cover body 131 having a space into which the image projector 200 may be inserted, and a coupling member 132 which protrudes from a lower surface of the cover body 131 in the shape of a pin to be detachably attached to the upper 110. However, the shape of the cover 130 is not limited to a character shape, and may be variously changed.

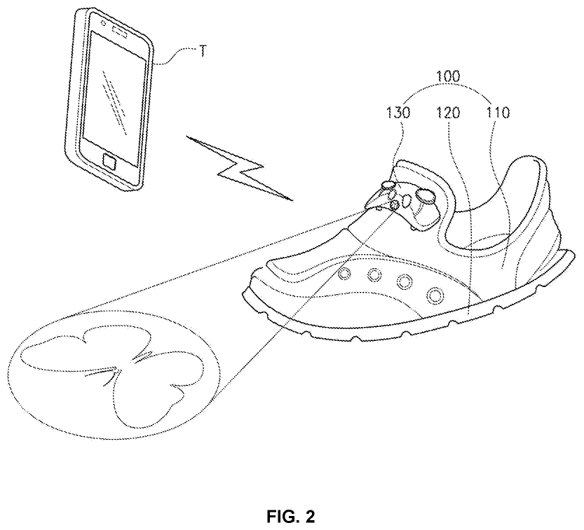

FIG. 2 is a view illustrating a state where an image is changed wirelessly in accordance with a preferred embodiment of the present invention. Referring to FIG. 2, the image projector 200 may change and project an image by wirelessly transmitting information of a terminal T such as an external separate smart phone.

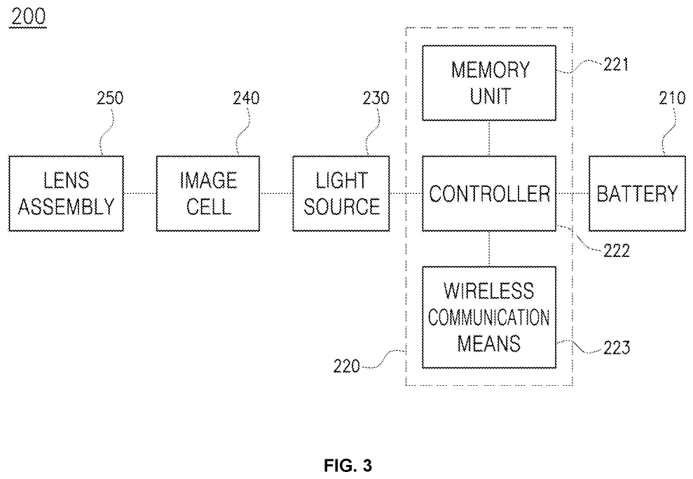

FIG. 3 is a schematic view of the image projector 200 in accordance with a preferred embodiment of the present invention. Referring to FIG. 3, the image projector 200 may include a battery 210, an image changing means 220, a light source 230, an image cell 240, and a lens assembly 250. Such a configuration will be described below in more detail.

The battery 210 of the present invention is configured to supply electrical energy.

That is, the battery 210 is an auxiliary means for supplying power energy to the image changing means 220, and serves as the fundamental power of the image changing means 220.

A dry cell to which power is supplied, a piezoelectric element and others may be used as such a battery 210. Several kinds of batteries may be used, for example, a disposable primary battery, designed to be thrown away after it has been used once, such as a manganese battery or an alkaline battery, and a secondary rechargeable battery, such as a nickel-cadmium (Ni—Cd) battery, a nickel-hydrogen (Ni-MH) battery, or a lithium-ion (Li-Ion) battery, which may be used again when it is recharged. In addition to the above-described battery 210, other types are possible as long as they function as the battery 210.

The image changing means 220 of the present invention is configured to transmit a control signal to the image cell 240 and thereby change an image that is to be projected.

In other words, the image changing means 220 may include a memory unit 221, a controller 222 and a wireless communication means 223 to receive information from a terminal T such as a separate smart phone and thereby change the image.

Thus, the image change information may be transmitted from the separate terminal T through the wireless communication means 223 to the image cell 240, thus attracting the interest when walking and effectively inducing a wearer's walking.

First, the memory unit 221 is configured to store multiple images. That is, the memory unit 221 is configured to have a space for storing various images that may be projected through the image cell 240 to the ground.

In other words, the memory unit 221 may include various kinds of software and information required for the operation of the controller 222, and may be operated such that various multiple images are generated and stored in one frame unit.

Particularly, the image changing means 220 may be further provided with a wireless communication unit (not shown). The wireless communication unit may be connected to the controller 222 so that the image stored in the terminal T may be uploaded to the wireless communication means 223 and then stored in the memory unit 221.

Second, the controller 222 is configured to load the image pre-programmed and stored in the memory unit 221 and then transmit the image to the image cell 240.

That is, the controller 222 plays a pivotal role in controlling the overall operation of the image changing means 220. The controller performs inputting and controlling operations to select any one of images stored in the memory unit 221 in response to a signal that is input by the wireless communication means 223 of the terminal T.

That is, the controller 222 reflects an image that is processed in the form of data on the image cell 240 based on the image change information received through the wireless communication means 223, thus causing the image to be projected to the ground by the light source 230.

Third, the wireless communication means 223 is configured to connect the controller 222 with the terminal T so as to transmit the image change information.

That is, in order to transmit the image change information to the image changing means 220, the wireless communication means 223 may be provided to connect the controller 222 with the terminal T.

In this regard, the wireless communication means 223 may selectively use any one of WLAN, Wi-Fi, and Bluetooth.

Meanwhile, as described above, the image is wirelessly changed by the wireless communication means 223. However, in place of changing the image by wireless, the image may be changed manually, which will be described below.

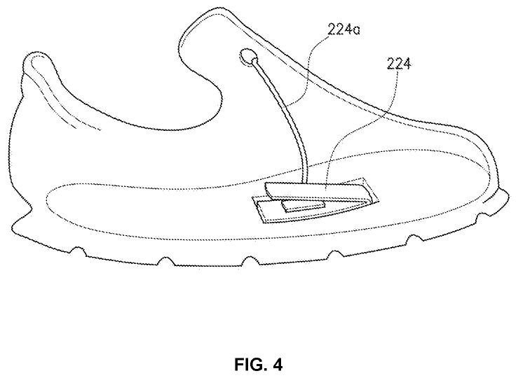

FIG. 4 is a view illustrating a state where the image is changed manually in accordance with a preferred embodiment of the present invention. Referring to FIG. 4, a change switch 224 connected to the image projector 200 through a connection cable 224a may be installed at the outsole 120. Although FIG. 4 illustrates that the change switch 224 is installed at the outsole 120, it is apparent that this may be installed at various positions without being limited to the outsole.

For example, the change switch 224 may be installed at the cover 130 via the connection cable 224a connected with the image projector 200 to be exposed to an outside of the cover 130, or may be installed at the upper 110 via the connection cable 224a connected with the image projector 200 to be exposed to an outside of the upper 110. Particularly, the change switch 224 performing an on/off function may be directly installed at a predetermined position of the image projector 200 such that the image projector 200 itself serves as a switch.

As seen in FIG. 4, the image may be manually changed using the change switch 224 unlike a method illustrated in FIGS. 2 and 3.

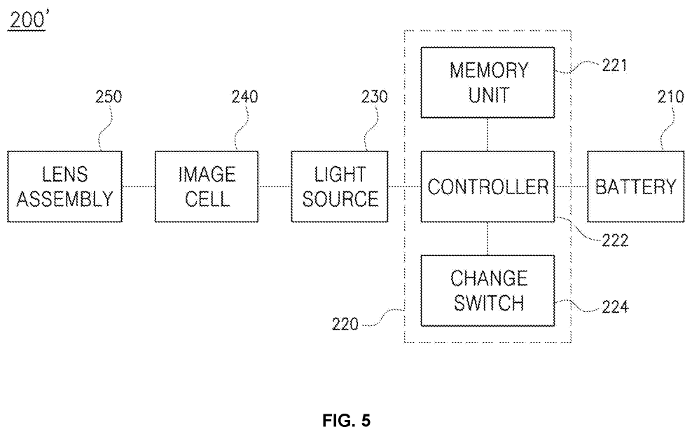

FIG. 5 is another schematic view illustrating an image projector 200′ in accordance with a preferred embodiment of the present invention. Referring to FIG. 5, it can be seen that the image projected to the ground is manually changed by the change switch 224, unlike the image projector 200 illustrated in FIG. 3.

In detail, the change switch 224 is connected to the controller 222 to manually change an image stored in the memory unit 221. When wearing shoes, multiple images stored in the memory unit 221 may be manually changed even if there is no wireless communication means 223.

The light source 230 of the present invention is configured to emit light.

In other words, the light source 230 is intended to emit light, and serves to visually show the image projected to the ground.

An additional configuration is as follows: a heat sink (not shown) may be formed at a predetermined position of the light source 230. Such a heat sink preferably absorbs and discharges heat that is generated from the light source 230.

The light source 230 may use a light emitting lamp or a LED. However, without being limited thereto, various light sources 230 may be used.

The image cell 240 of the present invention is installed in front of the light source 230 to create an image that is to be projected.

That is, the image cell 240 is film or glass that displays the image on the ground, and is installed in front of the light source 230 to receive the image information from the image changing means 220.

As such, if the light source 230 emits and irradiates light while the image is reflected on the image cell 240, the input image is exposed to the ground.

The lens assembly 250 of the present invention is installed in front of the image cell 240 to be spaced apart therefrom, and is configured to project the image formed on the image cell 240 towards the ground.

The lens assembly 250 receives the image of the image cell 240 from the light source 230 and disperses the image, so that the image is projected onto light passing through the lens assembly 250 and is exposed to a predetermined point of the ground.

Here, the lens assembly 250 may be made by variously changing any one of a concave lens, a convex lens and a plane lens. Thus, it is possible to control resolution of the image by concentrating or dispersing the light source 230.

For example, the convex lens and the concave lens may be disposed to face each other. In this case, when the light source 230 is emitted, light may be refracted by the convex lens and the concave lens to allow the image to be more smoothly dispersed.

While the present invention has been particularly described with reference to exemplary embodiments shown in the drawings, it will be understood by those of ordinary skill in the art that the exemplary embodiments have been described for illustrative purposes, and various changes and modifications may be made without departing from the spirit and scope of the present invention as defined by the appended claims.

Accordingly, embodiments of the present invention are intended not to limit the technical idea of the invention but to illustrate the technical idea. The scope of the present invention is not limited to the embodiments.

It is to be understood that the scope of the present invention is defined solely by the following claims and equivalences thereof.

What is claimed is:

1. A shoe capable of projecting images that can be changed, the shoe comprising a shoe body and an image projector detachably attached to the shoe body so as to project an image onto the ground,
wherein the image projector comprises:
a light source configured to emit light;
an image cell installed in front of the light source so as to form an image to be projected; and
image changing means configured to transmit a control signal to the image cell so as to change the image to be projected.

2. The shoe of claim 1, wherein the image projector further comprises:
a battery to which electrical energy is supplied; and
a lens assembly installed in front of the image cell to be spaced apart therefrom, and configured such that the image formed on the image cell is projected onto the ground.

3. The shoe of claim 2, wherein the lens assembly comprises at least one of a concave lens, a convex lens and a plane lens.

4. The shoe of claim 1, wherein the image changing means comprises:
a memory unit in which multiple images are stored; and
a controller controlling to load an image that is pre-programmed and is stored in the memory unit, and to transmit the image to the image cell.

5. The shoe of claim 4, wherein the image changing means further comprises:
wireless communication means connecting the controller with a terminal to transmit image change information.

6. The shoe of claim 5, wherein the wireless communication means comprises any one of WLAN, Wi-Fi, and Bluetooth.

7. The shoe of claim 4, wherein the image changing means further comprises:
a change switch connected to the controller to manually change the image stored in the memory unit.
